(19) United States
(12) Patent Application Publication
(10) Pub. No.: US 2025/0189356 A1
(43) Pub. Date: Jun. 12, 2025

(54) Alternate Drawdown Testing Method in Wastewater Lift Stations

(71) Applicant: Pardhasaradhi Namuduri, Houston, TX (US)

(72) Inventor: Pardhasaradhi Namuduri, Houston, TX (US)

(21) Appl. No.: 18/530,811

(22) Filed: Dec. 6, 2023

(51) Int. Cl. G01F 23/16

(52) U.S. Cl. CPC G01F 23/162

(57) ABSTRACT

A pressure transducer is modified to serve as a fill-level sensor sending a voltage signal to an analog-to-digital (a2d) converter and a data logger. The digital value of level is then assigned a date-time stamp and stored on a digital data storage medium. The modified pressure transducer is placed in a wet well where continuous fill-level measurements must be accomplished. The digital levels are processed for interpretation of time dependent fill profile.

### PATENT CLASSIFICATION

G01F 23/16 Indicating, recording, or alarm devices being actuated by mechanical, or fluid means, using gas, mercury, or a diaphragm as transmitting element, or by a column of liquid.
G06F ELECTRIC DIGITAL DATA PROCESSING (computer systems based on specific computational models G06N)
G06F 17/40. Data acquisition and logging (for input to computer G06F 3/00)
G06F 3/05. Digital input using the sampling of an analogue quantity at regular intervals of time {input from analog/digital converter or output to analog/digital converter}

### PREVIOUS WORK

The term “draw down test” or “drawdown test” in the context of water/wastewater pumping has been well-documented to study the performance of pumping equipment. The test procedure in these instances involves an offline setup with the goal of measuring flowrates, pumping heads, and other performance parameters. Refer: Joe Evens, Ph.D, http://www.Pumped101.com.

Use of portable, pressure transducers and integrated circuit (IC)-based dataloggers are also used in various portable devices with temperature and pressure sensors. Several embodiments are in use in transportation, medical and geophysical fields. Previous work in wastewater level sensing and data-logging has been mentioned in several review, research and scholarly articles relating to permanent instrumentation.

### BACKGROUND

A lift station adds static lift to an otherwise gravity flow of sewage from the point of generation to the point of discharge. A pump “lifts” fluids from lower elevation to a higher elevation through a discharge conduit, hence the term “lift” station. In many cases flow meters are not installed to quantify the actual flows delivered by the pumps. A drawdown test is performed to determine the actual flows delivered by a pump or a combination of pumps.

Drawdown Test: Pumps in a functional lift station operate in discrete cycles; several cycles of consecutive accumulation and evacuation of fluids in a wet well make the fluid transfer possible. Correspondingly, the water levels in a wet well rise and fall. Typically, water levels are measured either manually using a laser distance reader and a stopwatch, or automatically, using a SCADA system or a pump control system. In both scenarios, gross pumping rates are averaged over each cycle, often underestimating the instantaneous flows. These drawdown test methods are primitive and inaccurate. The drawbacks include: (a) no rational method to account for the inflows during pumping (b) Inflow variations during pump cycle are unaccounted for, and (c) non-uniform cross section of the wet well is not accounted for.

### SUMMARY OF INVENTION

The subject innovative approach encompasses the use of a pressure transducer and a data logger to record instantaneous fill levels, eliminating the need for manual tracking of the accumulation and evacuation cycles. The abundance of time-stamped fill level measurements eliminates the three drawbacks listed above. Portable test equipment, named Lamda-3 (Level And Monitoring based Data Acquisition-3), makes drawdown test possible while accounting for every second of inflows in each operation cycle. Manual measurements are error-prone and inaccurate. Non-uniform wet well cross sections can be easily accounted for using classical expressions for volume in known geometric shapes. A pressure transducer measures hydraulic pressure (head over sensor) as voltage instantaneously and continuously. These continuous voltage signals are converted to digital signals-typically every second and stored in a data logger. Data logs are processed offline and converted into flow profiles. Pressure and flow data can also be visualized on a rolling graph on a laptop screen.

### DETAILED DESCRIPTION

Measurement of pressure as voltage signal is a well-known principle of pressure transducers. Within a specific range of pressure, the magnitude of the voltage signal is directly proportional to the applied pressure. By installing a pressure transducer at a constant depth inside a structure where wastewater accumulates continuously (and pumped out periodically), the fill levels are measured as voltage signals and transmitted to an integrated circuit (IC) based data logger. The speed and abundance of electronic measurements and their role in construction of a drawdown curve are the hallmarks of this invention.

Power consumption in a voltage-based sensor is minimal relative to the current based signals. Powered by a simple battery pack, Lamda-3's portable nature allows drawdown tests using a convenient hardware and connectivity. IP-65 rated enclosure is custom designed to withstand the corrosive environment present in wastewater wet wells. The battery assembly enables continuous and uninterrupted data recording for several days.

As an essential service, wastewater collection must be operated without interruptions. But the health of lift station pumps cannot be easily monitored without installing expensive inline flowmeters. With Lamda-3 fill level measurements can be recorded under existing field conditions, while the pumps are fully operational. In the absence of standard test conditions or input from the pumping equipment, Lamda-3 can independently function without input or power from the pumping equipment. This characteristic is very valuable for the acceptance testing of a new pumpstation construction.

Permanent data loggers installed with automatic fill-level data collection are set-up for gross volume measurement and for billing purposes. The sampling frequency and data density are very low. Lamda-3's high data-density and sensitivity allow real time flow verification at any time. This high-resolution fill-level profile can quantify the surcharge, participation of each pump in a multi-pump operation, separation of inflows and pumping rates, and generation of pump curves in actual field conditions.

A surcharge condition in a wet well occurs when the wastewater level rises above the invert elevation of the lowest gravity inlet pipe. The presence of sewage above the inlet level causes the risk of sanitary sewer overflows (SSO) in the collection system. Many regulatory agencies prohibit the practice of surchaging the collection system due to risk groundwater contamination and potential for SSO in old collection networks subjected to infiltration and inflow (l/l).

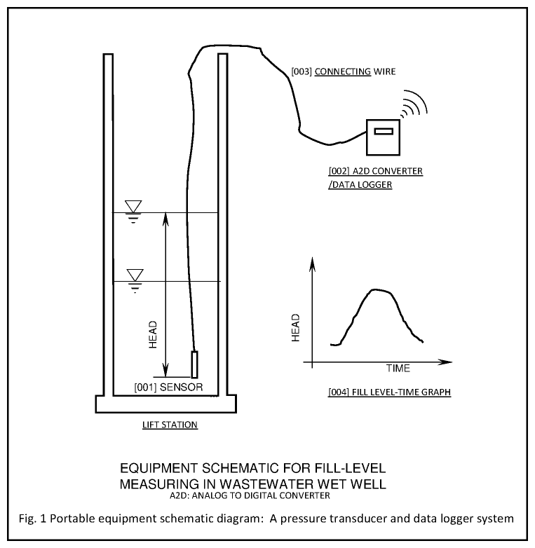

A schematic diagram is presented in FIG. 1 showing a [001] sensor, [002] analog-to-digital (a2d) convertor and a datalogger, [003] the connecting wires and [004] a drawdown curve are shown.

1. Abundant electronic fill-level measurements generated by a pressure transducer are utilized to construct water level profile, i.e., the drawdown curve, which is further analyzed to capture net inflows, pumping rates and effect of surcharge using high-frequency fill-level data in a wastewater lift station.

2. Surcharge effects are extracted from a drawdown curve using rational methods with expressions for the volume in a partially filled inclined pipe and other shapes including overflows, and pressure cell type varying wet well cross sections.

3. Portable apparatus characterized by lightweight components, low power consumption from a low-voltage battery uninterrupted powering of electronic components for several days, standalone operation, detachable assembly, and wireless enabled data access are all enabled by a pressure transducer [001], a digital converter-datalogger assembly [002], battery, IP-65 enclosure, interconnecting hard wiring [003] and other components.

4. Independent and standalone nature of alternate drawdown testing method using the subject invention named Lamda-3, without any data input or power from pumping equipment qualifies the method for acceptance testing and certification of pumping installations.
